(19) United States
(12) Patent Application Publication
(10) Pub. No.: US 2010/0300496 A1
(43) Pub. Date: Dec. 2, 2010

(54) CLEANING SYSTEM FOR OPTICALLY TRANSPARENT SURFACES

(76) Inventor: Alfred Souza, Orange, CA (US)

Correspondence Address: Loza & Loza LLP, 305 North Second Ave., #127, Upland, CA, 91786, US

(21) Appl. No.: 12/784,726

(22) Filed: May 21, 2010

Related U.S. Application Data
(60) Provisional application No. 61/181,233, filed on May 26, 2009.

(51) Int. Cl. B08B 3/04

(52) U.S. Cl. 134/104.4; 134/104.2

(57) ABSTRACT

Embodiments of the invention are directed to cleaning systems for optically transparent surfaces. In one embodiment, the system includes a reservoir integrally connected to (a) a non-recycled fluid transfer line and (b) a recycled fluid transfer line. A combination of non-recycled and recycled fluids housed in the reservoir may be integrally connected to at least one pump and one or more purifying apparatuses via one or more fluid transfer lines. In turn, one or more of the purifying apparatuses may be integrally connected to one or more spraying mechanisms apparatuses adjacent or substantially adjacent to an uppermost edge of one or more angled optically transparent surfaces via one or more fluid transfer lines. One or more troughs may be positioned adjacent to a lowermost edge of the one or more angled surfaces and integrally connected to the reservoir via one or more fluid transfer lines.

### CLAIM OF PRIORITY

This application claims priority to U.S. Provisional Application No. 61/181,233 filed May 26, 2009 and hereby incorporated by reference.

### FIELD OF INVENTION

Cleaning systems for optically transparent surfaces.

### BACKGROUND OF INVENTION

The rapid depletion of finite amounts of carbon-based natural resources such as oil and gas has caused a significant increase in the research, development and commercial implementation of renewable energy sources. Renewable energy is energy which comes from natural resources such as sunlight, wind, rain, tides, and geothermal heat, all of which are renewable (i.e., naturally replenished). Solar energy is the energy provided by sunlight, and when harnessed, it can be turned into electricity and heat. In most regions of the world, sunlight is plentiful, clean and renewable. Solar panels are the preferred technology used in harnessing sunlight to create renewable energy.

A solar panel, or a photovoltaic module, is an array of interconnected photovoltaic cells, or solar cells. The photovoltaic module is used as a component in a larger photovoltaic system to generate electricity. Commercially available silicone-based solar cells (poly and mono-crystalline) make up over 90% of all photovoltaic modules today. For both the poly and mono-crystalline panels, the base material utilized is silicon. The silicon is blended with boron, melted down and used to grow crystalline ingots. Then, the ingots are sliced into thin wafers and impregnated on one side with an element, typically phosphorous. A copper grid is buried in the wafer creating a plurality of solar cells. That is, each wafer with grids thereon is a solar cell. Multiple cells are sandwiched between a top layer of glass and a weather proof back layer to form a laminate. A framed laminate may also be called a module or panel.

Maximizing efficiency is challenging for commercially available solar panels. Efficiency is measured in sunlight conversion rates (module efficiencies) and can vary from about 5% to less than 45%. After installation, efficiency can be further compromised due to particulates collecting on the surface of the installed panels. It is estimated that solar panels can lose up to 30% of their efficiency due to environmental particulates which include airborne particulates such as dust, smog and pollen and deposited particulates such as water residue from rain, ice or snow and bird droppings.

### SUMMARY OF INVENTION

A cleaning system for optically transparent surfaces, comprising: a reservoir for storing an amount of fluid, the reservoir integrally connected to (a) a non-recycled fluid transfer line and (b) a recycled fluid transfer line; at least one pump integrally connected to the reservoir; at least one purifying apparatus integrally connected to the at least one pump; at least one spraying mechanism integrally connected to the at least one purifying apparatus; and a trough positioned a predetermined distance from the at least one spraying mechanism, the trough integrally connected to the reservoir via the recycled fluid transfer line is herein disclosed.

The at least one pump may be one of a positive displacement pump, a centrifugal pump, a diaphragm pump or a multi-diaphragm pump. The pump may be capable of transferring between 1 and 10,000 gallons per minute (gpm) of fluid at between 10 to 7,000 pounds per square inch (psi). The system may further comprise a control mechanism.

At least one purifying apparatus may include at least one particulate filter with a filter grade from between thirty (30) mesh to one (1) micron. In one embodiment, the at least one purifying apparatus is a de-ionizing tank having cationic media and anionic media. In another embodiment, the at least one purifying apparatus is a water softening tank or a reverse osmosis unit. The spraying mechanism may be an elongate tubular member having a plurality of apertures symmetrically spaced along the length thereof. A plurality of nozzles may be coupled to the plurality of apertures. The spraying mechanism may be positioned adjacent an uppermost edge of an optically transparent surface. The trough may be positioned adjacent a lowermost edge of the optically transparent surface. According to embodiments of the invention, the optically transparent surface may be a solar panel or a solar collector. The plurality of fluid transfer lines may connect the reservoir to the pump, the pump to the at least one purifying apparatus, and the at least one purifying apparatus to the spraying mechanism.

### BRIEF DESCRIPTION OF DRAWINGS

FIG. 1 illustrates a schematic of a cleaning system for optically transparent surfaces according to an embodiment of the invention.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to cleaning systems for optically transparent surfaces. In one embodiment, the system includes a reservoir integrally connected to (a) a non-recycled fluid transfer line and (b) a recycled fluid transfer line. A combination of non-recycled and recycled fluids housed in the reservoir may be integrally connected to at least one pump and one or more purifying apparatuses via one or more fluid transfer lines. In turn, one or more of the purifying apparatuses may be integrally connected to one or more spraying mechanisms apparatuses adjacent or substantially adjacent to an uppermost edge of one or more angled optically transparent surfaces via one or more fluid transfer lines. One or more troughs may be positioned adjacent or substantially adjacent to a lowermost edge of the one or more angled surfaces and integrally connected to the reservoir via one or more fluid transfer lines.

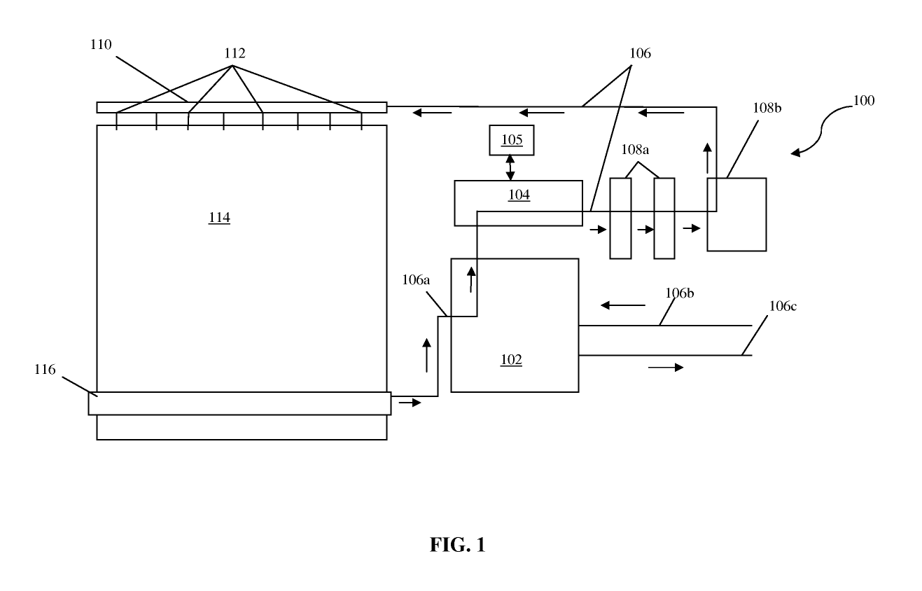

FIG. 1 illustrates a schematic of a cleaning system for optically transparent surfaces according to an embodiment of the invention. The system 100 may include a plurality of components integrally connected to one another except for between a spraying component and a trough component (explained in more detail below). In one embodiment, a reservoir 102 (or storage/receiving tank) of the system 100 stores a cleaning media received from one or more sources. More particularly, the reservoir 102 may store cleaning media received from a non-recycled source and a recycled source (explained in more detail below). “Cleaning media” may be water with (or without) natural and/or environmental contaminants, particles, minerals and/or elements and, in some instances, may include a dilute cleaning solution suitable for cleaning an optically transparent surface.

The storage/receiving tank 102 may be sized to hold a sufficient amount of cleaning media to clean one or more optically transparent surfaces (such as an array of solar panels positioned on a roof of a building) at a cleaning frequency of one or more times per week. In one embodiment, the storage/receiving tank 102 is a fifty-five (55) gallon drum; however, one of ordinary skill in the art will appreciate that the size of the storage/receiving tank 102 correlates to the number of surfaces the system 100 is set up to clean. In one embodiment, the storage/receiving tank 102 includes a lid or cover (not shown) to protect the cleaning media therein from natural and/or environmental contaminants and/or particles and a float valve (not shown) to control the level of the cleaning media in the storage/receiving tank 102 by introducing non-recycled cleaning media. The float valve may be manually, electrically, pneumatically or hydraulically controlled as known by one of ordinary skill in the art. Moreover, the float valve may be attached to a make-up source independent of its origin (i.e., from a recycled source or non-recycled source).

In one embodiment, the storage/receiving tank 102 is integrally connected to one or more pumps 104 via one or more fluid transfer lines 106. Generally, the pump 104 (and therefore the system 100) is controlled by a timer 105 including, but not limited to, a programmable logic controller, remote computer control, or any electrical or mechanical timer as known by one of ordinary skill in the art. Materials which comprise the fluid transfer lines 106 include, but are not limited to, polyethylene, polypropylene, nylon, polyvinyl chloride (PVC), chlorinated polyvinyl chloride (CPVC), a combination thereof, copper or any equivalent thereof. In one respect, each pump 104 functions to pump the cleaning media from the storage/receiving tank 102 and through one or more purifying apparatuses 108 (via one or more fluid transfer lines 106) and eventually to one or more spraying mechanisms 110 (via one or more fluid transfer lines 106). Examples of pumps 104 include, but are not limited to, a positive displacement pump, a centrifugal pump, a diaphragm or multi-diaphragm pump or any other device capable of transferring between one (1) and 10,000 gallons per minute (gpm) of cleaning media at between ten (10) to 7,000 pounds per square inch (psi) to the one or more spraying mechanisms 110. Although the pump 104 is illustrated positioned upstream relative to the purifying apparatuses 108, it should be appreciated that the pump 104 may be positioned downstream relative to the one or more purifying apparatuses 108.

In one embodiment, an outlet of each pump 104 may be integrally connected to one or more purifying apparatuses 108a, such as particulate filters, via one or more fluid transfer lines 106 followed by integrally connected to one or more purifying apparatuses 108b, such as a de-ionizing tank, also via one or more fluid transfer lines 106. The particulate filters 108a remove solid particulates from the cleaning media supplied from the storage/receiving tank 102 while the de-ionizing tank 108b remove ionic contaminants from the cleaning media. In one embodiment, the particulate filters 108a number two and range in filter grade from about thirty (30) mesh to less than about one (1) micron. The particulate filters 108a may be placed in any sequence; in one embodiment, the particulate filters 108a are positioned from the largest filter grade to the smallest filter grade relative to the pump 104.

Following passage through the particulate filters 108a, the cleaning media is then introduced into the de-ionizing tank 108b via one or more fluid transfer lines 106. Within the de-ionizing tank 108b, the cleaning media is partially, substantially or completely de-ionized by passing the cleaning media through (a) cationic media and/or (b) anionic media. In one embodiment, the cationic media and the anionic media are in separate vessels while, in another embodiment, the cationic media and the anionic media are combined in a single vessel. The cationic media may partially, substantially or completely remove any contaminants that are negatively charged (e.g., fluoride, etc.) while the anionic media may partially, substantially or completely remove any contaminants that are positively charged (e.g., magnesium, iron, etc.). Examples of cationic media include, but are not limited to, 8% cross-linked Gel Strong Acid Cation Exchange Resin, Na Form or Standard Macroporous Strong Acid Cation Exchange Resin, Na Form (available from U.S. Resin Company, Colorado, U.S.A.). Examples of anionic media include, but are not limited to, Standard Type 1 Gel Strong Base Anion Resin, OH Form or Standard Type 1 Macroporous Strong Base Anion, Cl Form (available from U.S. Resin Company, Colorado, U.S.A.).

In an alternative embodiment, de-ionization of the cleaning media may be achieved by a reverse osmosis process. According to this embodiment, a reverse osmosis unit (not shown) may partially, substantially or completely remove contaminants which are suspended, dissolved, and/or un-dissolved in the cleaning media by passing the cleaning media through a membrane as known by one of ordinary skill in the art. In yet another alternative embodiment, de-ionization of the cleaning media may be achieved by a water-softening process. According to this embodiment, a water-softening tank (not shown) may partially, substantially or completely remove contaminants (i.e., magnesium chloride and/or calcium chloride or any other contaminants known by one of ordinary skill in the art) which are suspended, dissolved, and/or un-dissolved in the cleaning media as known by one of ordinary skill in the art.

Following passage through the de-ionizing tank 108b, the treated cleaning media is introduced into one or more spraying mechanisms 110 via one or more fluid transfer lines 106. The cleaning media may be forced by the pump 104 through the one or more fluid transfer lines 106 under pressure to an uppermost edge of one or more angled optically transparent surfaces. In one embodiment, the spraying mechanism 110 is an elongate member, or tube, having a plurality of apertures 112 symmetrically spaced along the length of the spraying mechanism 110. The plurality of apertures 112 may be in communication with a plurality of nozzles (not shown), such as flood jet spray nozzles (available from RELAB Technologies, P.R.C.). In general, the system 100 utilizes a flooding process rather than a misting process found with conventional spray nozzles on the optically transparent surfaces. In this respect, the cleaning media essentially flows down the optically transparent surfaces in a sheet-like manner.

In one embodiment, the one or more angled optically transparent surfaces comprise an array of solar panels 114 positioned on a roof of a building. At the uppermost edge of each solar panel, the treated cleaning media is delivered from the spraying mechanism 110 via the one or more apertures 112 (or nozzles) along the surface of the solar panel 114. The spraying mechanism 110 may be positioned adjacent or substantially adjacent to an uppermost edge of each solar panel 114. The positioning of each spraying mechanism 112 relative to each solar panel 114 (i.e., adjacent or substantially adjacent to an uppermost edge of the solar panel 114) allows the cleaning media to essentially flow down the solar panel 114 in a sheet-like manner. In this respect, the treated cleaning media partially, substantially or completely removes natural and/or environmental contaminants and/or particles rendering the solar panel 114 clean and essentially spot free.

In one embodiment, a trough 116 is positioned adjacent or substantially adjacent to a lowermost edge of each solar panel 114. That is, the trough 116 is a predetermined distance from the spraying mechanism 110. The “predetermined distance” directly correlates to the size of the optical surface, i.e., solar panel. The trough 116 functions to collect the used cleaning media after flowing down (e.g., by gravity) each solar panel 114. From the trough 116, the used cleaning media is directed toward the storage/receiving tank 102 via one or more fluid transfer lines 106a (i.e., a recycled fluid transfer line). Thus, used cleaning media is provided to the storage/receiving tank 102 for retreatment and/or recycling thereof. That is, the cleaning media (e.g., treated, used water) can be re-used, or recycled, by passing it through the system 100 for treatment as previously described. However, because cleaning media is inevitably lost in the system through normal use, a transfer line 106b (i.e., a non-recycled fluid transfer line) integrally connected to the storage/receiving tank 102 supplements and/or augments new, non-recycled and/or fresh cleaning media (i.e., untreated, unused water) to the storage/receiving tank 102. Conversely, a transfer line 106c integrally connected to the storage/receiving tank 102 functions as an over-flow to allow for the drainage of collected rain water from the optically transparent surfaces. The over-flow water may be used for irrigation in compliance with Environmental Protection Agency (EPA) guidelines. In one embodiment, the pump 104 functions to pump cleaning media from the storage/receiving tank 102 to the trough 116 to backwash any collected solids therein.

The cleaning system according to embodiments of the invention as previously described presents several advantages over prior art systems. For example, the system may be fully automated by a programmable logic controller (PLC), remote computer or electrical mechanical timer (i.e., similar to a programmable lawn sprinkler system) which eliminates manual operation. Moreover, the system recycles water (in the case when the cleaning media is water) thereby significantly reducing water usage. Moreover, due to the nature of the treated water and the way in which it is delivered to the surface of an optical surface (i.e., in a sheet-like manner), the system results in a spot free or substantially free optical surface (i.e., solar panel). Moreover, the system can be used daily, weekly, monthly, bi-monthly, etc., if desired, with maximum cleaning effect and minimal cost and loss of water (in the case when the cleaning media is water).

Moreover, and specifically with respect to solar panels, by cleaning the surfaces thereof with the treated water resulting from the system as previously described, the solar panels realize improved efficiency. That is, airborne particulates such as dust, smog and pollen and deposited particulates such as water residue from rain, ice or snow and bird droppings which naturally collect on solar panels surfaces may be partially, substantially or completely removed from the solar panel surfaces by the system as previously described to greatly increase their efficiency, lifetime and functionality. Additionally, the system as previously describes eliminates the use of a cleaning solution (i.e., soap) which inevitably leaves deposits on solar panels thereby decreasing their efficiencies.

Other applications of the system as previously described include, but are not limited to, the cleaning of solar heating panels and solar hot water panels typically used for pool heating and for heating household tap water. Solar water heating (or solar hot water) is water heated by solar energy utilizing solar collectors, a water storage tank, inter-connected pipes and a fluid system to move the heat from the collectors to the water. Solar water heating heats water directly. In one embodiment, the solar collector is made of a glass top and insulated box with flat solar absorbers made of sheet metal attached to copper pipes and painted black or a set of metal tubes surrounded by an evaporated glass cylinder. Water heated by the collector can be stored directly in a storage tank of water. In any event, the collectors of any configuration are similar to a solar panel in that they collect dust, dirt, etc. and require cleaning to maximize heat transfer to the water.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A cleaning system for optically transparent surfaces, comprising:
a reservoir for storing an amount of fluid, the reservoir integrally connected to (a) a non-recycled fluid transfer line and (b) a recycled fluid transfer line;
at least one pump integrally connected to the reservoir;
at least one purifying apparatus integrally connected to the at least one pump;
at least one spraying mechanism integrally connected to the at least one purifying apparatus; and
a trough positioned a predetermined distance from the at least one spraying mechanism, the trough integrally connected to the reservoir via the recycled fluid transfer line.

2. The system of claim 1 wherein the at least one pump includes one of a positive displacement pump, a centrifugal pump, a diaphragm pump or a multi-diaphragm pump.

3. The system of claim 2 wherein the pump is capable of transferring between 1 and 10,000 gallons per minute (gpm) of fluid at between 10 to 7,000 pounds per square inch (psi).

4. The system of claim, further comprising, a control mechanism.

5. The system of claim 1 wherein at least one purifying apparatus includes at least one particulate filter with a filter grade from between thirty (30) mesh to one (1) micron.

6. The system of claim 1 wherein at least one purifying apparatus is a de-ionizing tank having cationic media and anionic media.

7. The system of claim 1 wherein at least one purifying apparatus is a water softening tank or a reverse osmosis unit.

8. The system of claim 1 wherein the spraying mechanism is an elongate tubular member having a plurality of apertures symmetrically spaced along the length thereof.

9. The system of claim 1, further comprising, a plurality of nozzles coupled to the plurality of apertures.

10. The system of claim 8 wherein the spraying mechanism is positioned adjacent an uppermost edge of an optically transparent surface.

11. The system of claim 10 wherein the trough is positioned adjacent a lowermost edge of the optically transparent surface.

12. The system of claim 11 wherein the optically transparent surface is a solar panel or a solar collector.

13. The system of claim 1 wherein a plurality of fluid transfer lines connect the reservoir to the pump, the pump to the at least one purifying apparatus, and the at least one purifying apparatus to the spraying mechanism.
